(19) United States
(12) Patent Application Publication
(10) Pub. No.: US 2024/0342703 A1
(43) Pub. Date: Oct. 17, 2024

(54) RAISED FLUIDIC CHANNELS AND METHODS OF MANUFACTURE

(71) Applicant: National Research Council of Canada, Ottawa (CA)

(72) Inventors: Zhiyi ZHANG, Ottawa (CA); Ye TAO, Ottawa (CA); Jianping LU, Ottawa (CA); Gaozhi XIAO, Ottawa (CA)

(21) Appl. No.: 18/701,079

(22) PCT Filed: Oct. 12, 2022
(86) PCT No.: PCT/CA2022/051498

§ 371 Date: Apr. 12, 2024

Related U.S. Application Data
(60) Provisional application No. 63/255,243, filed on Oct. 13, 2021.

(51) Int. Cl. B01L 3/00

(52) U.S. Cl. CPC B01L 3/5023; B01L 3/502715; B01L 2300/069; B01L 2300/0825; B01L 2300/0864; B01L 2400/0406

(57) ABSTRACT

A ridge fluidic device comprising: a substrate and a fluidic component comprising at least one fluidic channel, wherein the at least one fluidic channel is adapted to conduct a fluid and retain the fluid within the at least one fluidic channel: wherein the at least one fluidic channel comprises porous material having a hydrophilic surface; and wherein the at least one fluidic channel is formed on the substrate via a deposition process.

### FIELD

Aspects of this disclosure relate to methods and systems for fluid delivery.

### BACKGROUND

Microfluidic devices have found increasing applications in many areas, such as, in biology and chemistry-related areas. Such microfluidic devices are paper-based or are fabricated from silicon, glass, and polymers. In contrast to microfluidic devices based on silicon, glass, and polymers, paper-based devices do not require external equipment, such as a pump, and the fabrication process is less complex, more affordable, user-friendly, and more ubiquitous. Typically, paper-based microfluidic devices are fabricated by introducing a hydrophobic material such as wax into filter papers to create hydrophobic barrier, or walls, to pattern the hydrophilic channels embedded in the paper. Alternatively, the hydrophilic paper can be first modified to be hydrophobic and then a chemical is applied to transform certain areas to be hydrophilic in order to create microfluidic channels.

The process for fabricating the paper-based devices is associated with relatively high fabrication costs due to numerous design constraints. For example, the dimensions of the fabricated channels mostly depend on the characteristics of the paper, such as the thickness of the paper which makes it challenging to manipulate the channels in a controlled fashion, including the chemistry of the paper. Accordingly, it is challenging to reduce the channel dimensions for applications associated with nano-sized samples. In addition, the paper-based devices are relatively more challenging to integrate with other components, such as conductive circuits, and sensing units.

### SUMMARY

In one aspect of the disclosure, there is provided a ridge fluidic device comprising:
a substrate:
a fluidic component comprising at least one fluidic channel, wherein the at least one fluidic channel is adapted to conduct a fluid and retain the fluid within the at least one fluidic channel;
wherein the at least one fluidic channel comprises at least one porous material having a hydrophilic surface; and
wherein the at least one fluidic channel is formed on the substrate via a deposition process.

In another aspect of the disclosure, there is provided a ridge fluidic device comprising:
a substrate:
at least one fluidic channel deposited on the substrate, wherein the at least one fluidic channel is adapted to conduct a fluid and retain the fluid within the at least one fluidic channel, and wherein the at least one fluidic channel comprises at least one porous material having a hydrophilic surface and a binder.

In another aspect of the disclosure, there is provided a method of fabricating a fluidic device, the method comprising:
depositing on a substrate material comprising a porous material with a hydrophilic surface, wherein the at least one fluidic channel is adapted to conduct a fluid and retain the fluid within the at least one fluidic channel.

Ridge fluidic channels on a substrate are used to conduct fluid and retain the fluid within channels. The channels are directly formed by depositnig hydrophilic porous materials on a substrate through printing and other processes. The fluidic channels can be easily integrated with various components through the deposition.

### BRIEF DESCRIPTION OF THE DRAWINGS

FIG. 1 shows an exemplary structure of a ridge fluidic channel:

FIGS. 2a-d show a paper-cut microfluidic channel placed on a polyethylene terephthalate (PET) film in which printing ink was dropped at an inlet of a channel and travelled along the channel from a position shown in FIG. 2b to a position shown in FIG. 2d:

FIGS. 3a-c show a raised fluidic device with printed channels in a star configuration and its performance in transporting water, recorded time at t=0 seconds (FIG. 3a): t=3 seconds (FIG. 3b); and t=6 seconds (FIG. 3c);

FIG. 3d shows a side view of the fluidic device of FIG. 1;

FIGS. 4a-c show a raised fluidic device with printed channels in a Y configuration and its performance in transporting water recorded time at t=0 seconds (FIG. 4a): t=8 seconds (FIG. 4b); and t=17 seconds (FIG. 4c):

FIG. 5 shows an exemplary structure of a fluidic device integrated with absorption and transportation materials:

FIG. 6 shows an exemplary structure of another fluidic device integrated with absorption and transportation materials:

FIG. 7 shows an exemplary structure of a microfluidic channel device integrated with a conductive circuit; and

FIG. 8 shows an exemplary structure of a layered 3D-ridge fluidic device with microfluidic or nanofluidic channels integrated with a conductive circuit.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

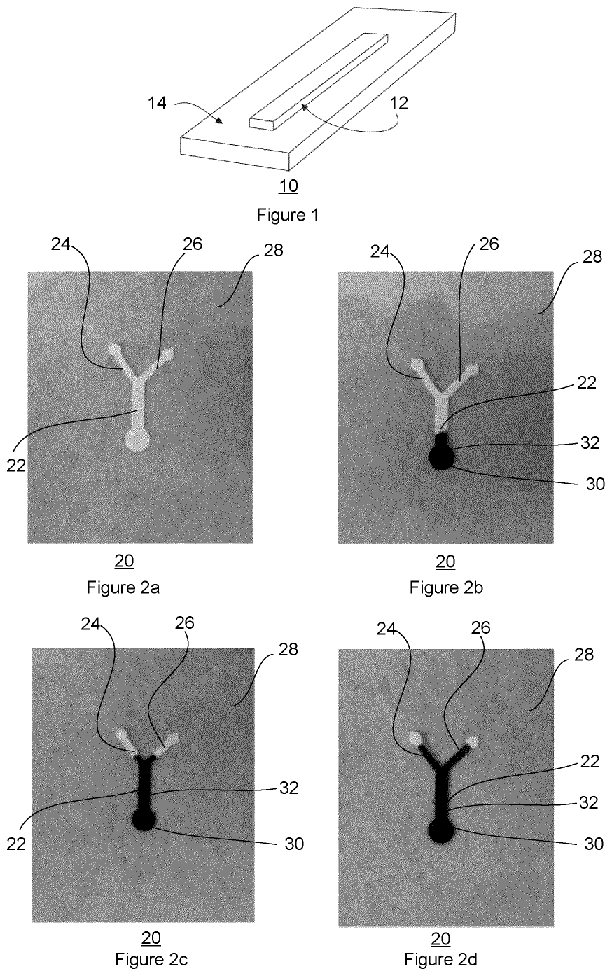

Referring to FIG. 1, there is shown an exemplary structure of a fluidic device 10 comprising a ridge fluidic channel 12 on a substrate 14. The ridge fluidic channel 12 is configured to retain a fluid within its confines and conduct a stream of the fluid from one location of the ridge fluidic channel 12 to another location of the ridge fluidic channel 12. As can be seen in FIG. 1, the ridge fluidic channel 12 is a raised structure on the substrate 14, such as a polymer or polymer-coated substrate. In one example, the fluid transportation within the ridge fluidic channel 12 is achieved by capillary effect, as the fluid is confined in the hydrophilic region of the ridge fluidic channel 12 by virtue of the substrate 14 being less hydrophilic and the surrounding atmosphere or air lacks any mechanism sufficient to force the fluid out of the ridge fluidic channel 12. The fluid may include liquids, such as water, water-based samples or samples in an aqueous solution.

In one example, filter paper is cut using laser to form an exemplary Y-shaped microfluidic device 20 with a stem channel 22 and two Y-junction channels 24, 26. The Y-shaped microfluidic device 20 is placed freely onto a PET substrate 28, as shown in FIG. 2a. A water-based ink 30 is placed on an inlet 32 of the Y-shaped microfluidic device 20, and as can be seen in FIGS. 2b-2d, the water-based ink travels along the stem channel 22 after a period of time, and then reaches the two Y-junction channels 24, 26. As evidenced by FIGS. 2b-2d, the water-based ink stays within the Y-shaped microfluidic device 20 without leaking out from the edges of the filter paper, despite the fact that the stem channel 22 and the two Y-junction channels 24, 26 lack any surrounding walls. This phenomenon is achieved by the capillary force inside the stem channel 22 and the two Y-junction channels 24, 26, which comprise hydrophilic fibers. Consequently, the fabrication of the device 20 is substantially less complex and the associated fabrication costs are significantly reduced. In contrast, fluidic devices made from glass, silicon, ceramics and polymers require channel walls to confine liquids within the channels and the fluidic flow is typically driven by pressure or other mechanisms.

In another example, the microfluidic device 20 is capable of similar fluidic transportation when it is suspended in air using plastic fibers without contacting any substrate 28. Accordingly, the raised fluidic channels 22, 24 and 26 are capable of fluidic transportation and retaining fluids with a substrate or without contacting a substrate. The channels 22, 24 and 26 may be covered by using a hydrophobic polymer film at a low cost through taping, lamination, coating, printing and other processes. The hydrophobic polymer film acts to protect the channels 22, 24 and 26 from contamination or damage. In this case, the channels 22, 24 and 26 become embedded within the polymer. As such, the process for protecting the channels 22, 24 and 26 is relatively easy and substantially less expensive than existing fabrication processes of paper-based channels.

In one example, the channels 22, 24 and 26 are fabricated by depositing a porous material. The material may be deposited on to a substrate 28 using a printing process or a dispersing process. The porous material comprises open and interconnected pores with hydrophilic pore surface, and further comprise pores of varying dimensions, such as small pores and large pores, which are combined to transport liquids efficiently. For example, the small pores, in nanometer-scale, are effective in keeping the materials strong and smooth, and for absorbing liquids into the materials, while the large pores, mostly in micrometer scale, are effective in moving fluid to a significant distance using the associated capillary effect. The combined effect of the nanopores and the micropores thus creates an efficient fluid transportation mechanism for the materials, while keeping the materials strong. As the surface of the porous material is hydrophilic and their volume percentage in the material is relatively high, liquids, such as water, may be transported within the material by capillary force, in the same fashion as in embedded paper-based devices.

In one example, the nanopores are formed by incorporating hydrophilic nanoparticles, such as porous silica and alumina nanoparticles, into a hydrophilic polymer binder. Micropores may be formed by blending hydrophilic microparticles, such as silica and alumina microparticles, with a mixture of the nanoparticles and a polymer binder. Hydrophilic polymers that are capable of holding the particles in place may be used as the binder. Exemplary hydrophilic polymers include polyvinyl alcohol (PVA), cellulous, among others. Accordingly, the porous materials may be prepared as an ink that can be printed on a substrate with standard printing processes, such as screen printing, flexo printing, blade coating, among others.

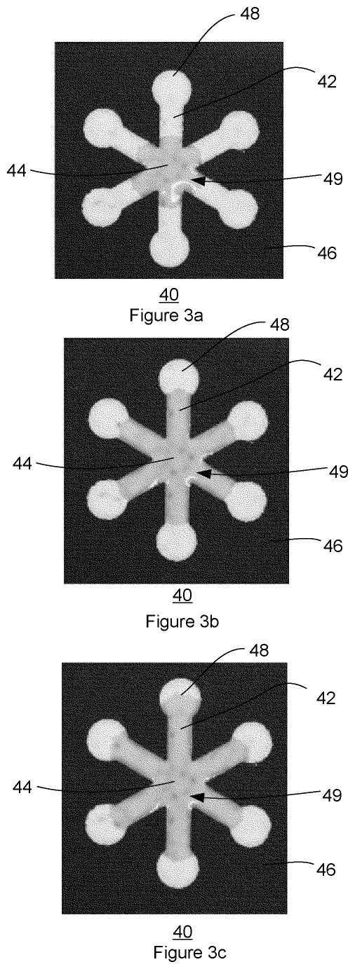

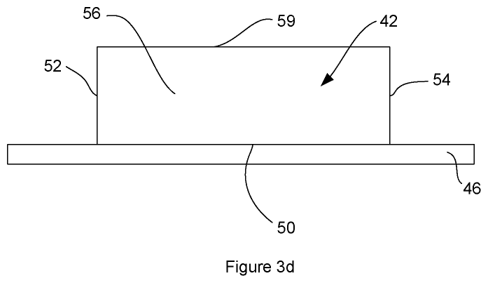

In one example, fumed silica nanoparticles, alumina microparticles with small and large diameters, and PVA are used to formulate the ink using dimethyl sulfoxide (DMSO) as a solvent. The ink is printed on PET films using a screen printer and dried at 120° C. FIGS. 3a-3c show exemplary device 40 with a plurality of channels 42 extending from a central location 44, in a star configuration, on a PET substrate 46. Each of the plurality of channels 42 comprises endpoint 48, respectively. A drop of water 49 is applied on the central location 34, and the water remains within the confines of the channels 42 while being transported to the plurality of channels 42. As shown in FIG. 3d, the PET substrate 46 interfaces a bottom surface 50 of the channels 42 and acts as an inert barrier and prevents water penetration, while the atmosphere or air on the side surfaces 52, 54 and 56, 58 (not shown) and upper surface 59 prevent water from leaving the device 40 solely by virtue of the hydrophilic nature of the device materials that are able to keep water within the pores. As mentioned previously, the surrounding atmosphere or air lacks any mechanism sufficient to force the fluid out of the channels 42. In contrast, in a paper-based microfluidic channel, inert materials, such as wax and hydrophobic polymer, are introduced into the paper to build a physical barrier (i.e. channel wall) to keep water within the channel, and the obtained channels are embedded in the paper. In comparison to paper-based microfluidic devices, the printed raised fluidic devices are much easier to fabricate with a lower cost.

Fluid transportation performance in the printed channels may be dictated by the ink formulation, as well as the composition of the porous materials. As the micropores promote efficient transportation of liquids for longer distances, the hydrophilic microparticles may be composed of 55% to 85% by volume of the solid in the materials, while the nanoparticles may be composed of 5% to 30% by volume of the solid in the materials. Generally, a high concentration of the total particles favours efficient liquid transportation, however, overloading of the particles may reduce the mechanical strength of the printed materials and their adhesion to the substrate. Accordingly, an optimal range for the particle concentration is desirable. These particles may be used in a dried phase or in-water dispersed phase. The surface of the particles is capable of maintaining their natural hydrophilic nature, or may be modified for improved hydrophilicity.

A binder is be used to hold the particles together and provide the adhesion to the substrate. One suitable binder is hydrophilic by nature and is compatible with the hydrophilic particles, such as polyvinyl alcohol (PVA). In one example, 10% to 30% by volume of the binder in solid of the materials is useful for formulating the materials that can be printed using a conventional printer, such as screen printers. The printed channels also comprise sufficient mechanical strength and good adhesion to substrates, and are printed with the materials can transport water efficiently, even when the binder concentration is at a low end of the above-noted range. Generally, the less the binder in the dried material, the faster the fabricated device can transport water. However, low concentration of binder may negatively affect the mechanical strength of the fabricated channels and the adhesion of the channels to the substrate. Consequently, the binder concentration is optimized for fluidic transport, mechanical strength of the channels, and adhesion of the channels to the substrate.

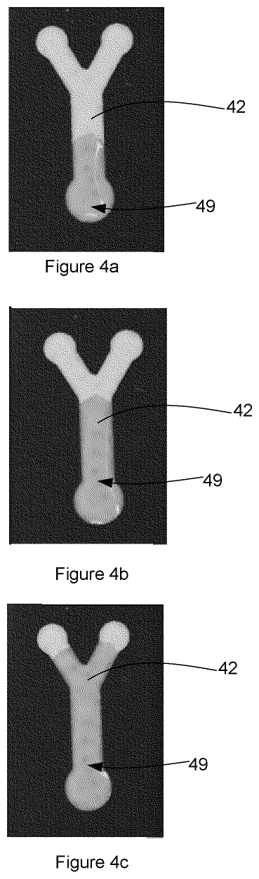

In one example, microfluidic devices may be fabricated by using the materials to print wider and thicker film channels. As an example, the thickness of the channel shown in the microfluidic devices of FIGS. 3a-3c and 4a-4c is approximately 30 micrometers and can feed 20-80 microliters of water. The sampling capacity of the microfluidic devices may be changed by manipulating the film thickness through formulation and printing process. In one example, the sampling capacity can be substantially reduced to nanoliter level by printing narrower and thinner film or channel. In another example, nanofluidic devices with nanofluidic channels comprising a width of several hundred micrometers and a thickness of several micrometers may be printed with the materials using flexo printing, screen printing and other printing methods. Such nanofluidic devices are capable of handling nanoliter samples. In comparison, paper-based devices are not capable of being fabricated channels that are sufficiently narrow to handle nanoliter samples, and such devices can only handle microliter samples.

As the raised channels can be printed using the described materials and methods, the devices can be easily integrated with other components for implementation of various comprehensive functionalities. Functional integration may be achieved through formulation change, for example, since nanoparticles facilitate liquid absorption and microparticles facilitate liquid transportation, the materials with only nanoparticles or with large amount of nanoparticles and small amount of nanoparticles can be formulated for absorption only. For instance, a material that mainly absorbs water can be formulated by using nano silica and by controlling the concentration of nano silica, to about 80%, and using PVA as a binder. Other binders include cellulose, polyvinyl acetate, or copolymer like ethylene vinyl acetate (EVA) vinyl acetate ethylene (VAE) and other styrene-acrylic copolymers.

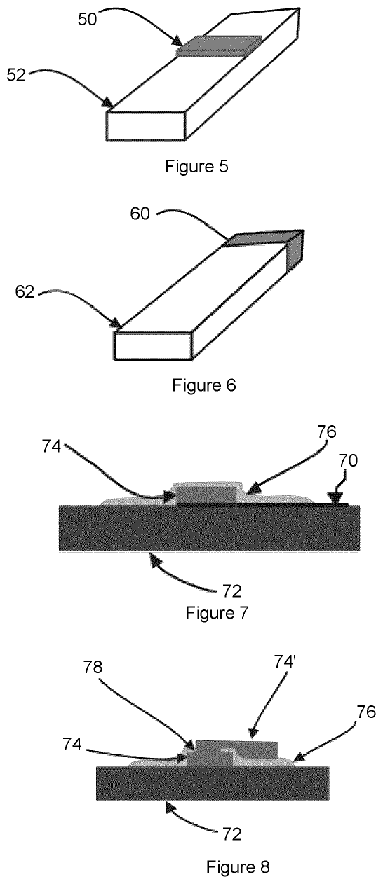

The ability of fabricating fluidic devices via deposition process, such as printing, allows for such integration and gives birth to a plethora of new devices. For example, when the above absorptive materials are integrated with the materials that can transport water through printing process, new devices can be fabricated. In one example, an absorptive material 60 is attached as a thin layer through printing to a printed raised fluidic channel 62 that can transport water, as shown in FIG. 5. When a reagent A is applied on the thin absorptive layer 60 from its upper surface, reagent A can be absorbed into the layer 60 and stay in the layer 60. The dried absorptive layer 60 may also absorb the fluidic sample transported in the raised fluidic channel 62. If the sample contains a reagent B, which is reactive with agent A, a reaction of the two agents may occur in the absorptive layer 60. In this case, the absorptive layer 60 acts as a reaction site. By increasing the area of the absorptive layer 60 either to a continuous long piece or to several discrete pieces to increase its contact area with the raised fluidic channel 62, various agents can be doped into the layer as some separate zones and thus separate reaction sites.

The integration of the two types of materials can be manipulated in many ways. Besides the stacked structure shown in FIG. 5, an absorptive layer 60 may be printed first on a substrate and doped with agents, followed by printing a fluidic channel 62 on the absorptive layer 60. Alternatively, the absorptive layer 60 and the fluidic channel 62 may be printed on the same substrate and may be connected laterally as shown in FIG. 6. For example, the absorptive zone 60 can be arranged at the end of a fluidic channel 62 or between two or more channels 62. In the latter case, each fluidic channel 62 can be used to transport a particular fluidic sample to the absorptive zone 60 for interacting with the absorption zone 60.

In addition to the described integration, the raised fluidic channels 62, both microfluidic and nanofluidic, can be easily integrated with other components such as electrodes. For instance, conductive circuits can be first printed on the substrate and the raised fluidic channels are deposited over the top in certain area. As such, the printable electronic is integrated with the fluidic device in compatible processes. FIG. 7 shows a cross section of an integrated device. In this example, a conductive circuit 70 is first printed on a polymer substrate or polymer-coated substrate 72, and a raised channel 74 is then printed on the conductive circuit 70. In certain areas, the fluidic channel 74 is directly over the conductive trace 70 such that the liquid travels in the channel 74, and comes into contact with the conductive trace 70. In one example, a protection layer 76 may be applied over the fluidic channel 74 and the conductive trace 70.

In one example, the raised channel concept can be used to print 3D structures, as shown in FIG. 8. For example, a protection layer 76 is applied on the raised microfluidic channels 74 and additional raised fluidic channels 74′ may be added on top of a preceding channel 74 through printing and other processes, and may include an interlayer connection 78 between channels 74 and 74′. As the protection layer 76 may be easily patterned through printing, the process of adding the upper microfluidic channels 74′ can easily allow the material to connect the bottom channel, as illustrated in FIG. 8.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments are described above with reference to block diagrams and/or operational illustrations of methods, systems. The operations/acts noted in the blocks may be skipped or occur out of the order as shown in any flow diagram. For example, two or more blocks shown in succession may be executed substantially concurrently or the blocks may sometimes be executed in the reverse order, depending upon the functionality/acts involved. While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments.

1. A ridge fluidic device comprising:
a substrate;
a fluidic component comprising at least one fluidic channel, wherein the at least one fluidic channel is adapted to conduct a fluid and retain the fluid within the at least one fluidic channel;
wherein the at least one fluidic channel comprises at least one porous material having a hydrophilic surface; and
wherein the at least one fluidic channel is formed on the substrate via a deposition process.

2. The ridge fluidic device of claim 1, wherein the fluid flow is conducted by a capillary force.

3. The ridge fluidic device of claim 1, wherein the at least one fluidic channel comprises at least one of a microfluidic and a nanofluidic channel.

4. The ridge fluidic device of claim 3, wherein the at least one fluidic channel is deposited on a surface by at least one of a screen printing, flexo printing, and blade coating.

5. The ridge fluidic device of claim 4, wherein the ridge fluidic device is integrated with other components via multi-layer deposition.

6. The ridge fluidic device of claim 5, wherein the other components comprise at least one an electronic component and a photonic component.

7. The ridge fluidic device of claim 1, wherein at least one material comprises at least one nanoparticle with a diameter less than 200 nanometers and at least one microparticle with a diameter within a range of 1 to 30 micrometers.

8. The ridge fluidic device of claim 7, wherein the at least one nanoparticle and at least one microparticle comprise at least one of silica, alumina and other materials with high surface energy.

9. The ridge fluidic device of claim 7, wherein the at least one nanoparticle is within 5-30% and at least one microparticle is within a range of 55% to 85% of the total solid content.

10. The ridge fluidic device of claim 7, wherein the at least one material comprises a binder.

11. The ridge fluidic device of claim 10, wherein the binder is chosen from a group consisting of polyvinyl alcohol (PVA), cellulose, polyvinyl acetate, or copolymer like ethylene vinyl acetate (EVA) vinyl acetate ethylene (VAE) and other styrene-acrylic copolymers.

12. The ridge fluidic device of claim 10, wherein the binder is within a range of 10% to 30% by volume of the total solid content.

13. The ridge fluidic device of claim 1, wherein the at least one fluidic channel is integrated with materials that can effectively absorb liquid but not transport liquid to a significant distance.

14. The ridge fluidic device of claim 13, wherein the materials comprise nanoparticles with a hydrophilic surface and a hydrophilic binder.

15. The ridge fluidic device of claim 14, wherein the nanoparticles comprise a concentration of 70%-90% by volume of the total solid content.

16. The ridge fluidic device of claim 14, wherein the materials comprise nanoparticles with a concentration of 60%-80% and microparticles by volume of the at least one porous material solid content and with a concentration of 10% and less of the total solid content.

17. The ridge fluidic device of any one of claims 1 to 16, wherein the materials are integrated to the at least one fluidic channel directly through a printing process.

18. The ridge fluidic device of any one of claims 1 to 16 wherein the materials are integrated to the at least one fluidic channel directly through a coating process.

19. The ridge fluidic device of claim 18, wherein the at least one fluidic channel comprises an upper surface, at least one side surface, and a lower surface.

20. The ridge fluidic device of any one of claims 1 to 19, wherein the at least one fluidic channel comprises a volume capacities, depending on the materials used to fabricate and mostly on the dimension of the raised structure.

21. The ridge fluidic device of claim 20, wherein the at least one fluidic channel is directly integrated with at least one an electrical circuit, a photonic circuit and a sensing element on the same substrate.

22. The ridge fluidic device of claim 21, wherein the at least one an electrical circuit, the photonic circuit and the sensing element are on the same substrate surface as the at least one channel.

23. A ridge fluidic device comprising:
a substrate:
at least one fluidic channel deposited on the substrate, wherein the at least one fluidic channel is adapted to conduct a fluid and retain the fluid within the at least one fluidic channel, and wherein the at least one fluidic channel comprises at least one porous material having a hydrophilic surface and a binder.

24. A method of fabricating a fluidic device, the method comprising:
depositing on a substrate a material comprising at least one porous material having a hydrophilic surface and a binder to form at least one fluidic channel, wherein the at least one fluidic channel is adapted to conduct a fluid and retain the fluid within the at least one fluidic channel.

25. The method of claim 24, wherein at least one porous material comprises at least one silica and alumina particles.

26. The method of claim 25, wherein at least one porous material comprises particles with a diameter within a range of 1 to 30 micrometers.

27. The method of claim 25, wherein the particles are within a range of 55% to 85% of at least one porous material solid content.

28. The method of claim 25, wherein the at least one porous material comprises a binder.

29. The method of claim 28, wherein the binder is chosen from a group consisting of polyvinyl alcohol (PVA), cellulose, polyvinyl acetate, or copolymer like ethylene vinyl acetate (EVA) vinyl acetate ethylene (VAE) and other styrene-acrylic copolymers.

30. The method of claim 29, wherein the binder is within a range of 10%-30% by volume of the at least one porous material solid content.

31. The method of claim 24, wherein the at least one fluidic channel is integrated with materials that can effectively absorb liquid but not transport liquid.

32. The method of claim 31, wherein the materials comprise nanoparticles with a hydrophilic surface and a hydrophilic binder.

33. The method of claim 32, wherein the nanoparticles comprise a concentration of 70%-90% by volume of the at least one porous material solid content.

34. The method of claim 32, wherein the nanoparticles comprise a concentration of 60%-80% by volume of the at least one porous material solid content and a concentration of 10% of silica or alumina microparticles.

35. The method of claim 34, wherein the nanoparticles comprise a a binder with a concentration of 10%-30% by volume of the at least one porous material solid content.

36. The method of any one of claims 24 to 35, wherein the materials are integrated to the at least one channel directly through a printing or a coating process.
